(19) United States
(12) Patent Application Publication
(10) Pub. No.: US 2021/0405118 A1
(43) Pub. Date: Dec. 30, 2021

(54) Monitoring System and Monitoring Method

(71) Applicant: Hitachi, Ltd., Chiyoda-ku, Tokyo (JP)

(72) Inventors: Akihiro NAKAMURA, Tokyo (JP); Kenta DEGUCHI, Tokyo (JP); Yoshitaka IWAJI, Tokyo (JP)

(21) Appl. No.: 17/285,700

(22) PCT Filed: Oct. 1, 2019
(86) PCT No.: PCT/JP2019/038679

§ 371 Date: Apr. 15, 2021

(30) Foreign Application Priority Data
Oct. 18, 2018 (JP) 2018-196377

(51) Int. Cl. G01R 31/34; G01R 23/02; G06F 30/20

(52) U.S. Cl. CPC G01R 31/343; B23Q 17/09; G06F 30/20; G01R 23/02

(57) ABSTRACT

An object of the present invention is to provide a technique for monitoring the condition of a device or a target processing object.

A monitoring system according to one aspect of the present invention monitors a device powered by an AC motor and estimates a condition of at least one of the device or a target processing object of the device, and includes a time-series data acquisition unit configured to acquire voltage data relating to a drive voltage of an AC motor; a feature value computation unit configured to analyze a feature value of an abnormal voltage waveform in a time-series waveform of the voltage data; and a state estimation unit configured to estimate the condition based on the feature value of the abnormal voltage waveform.

### TECHNICAL FIELD

The present invention relates to a monitoring system and a monitoring method.

### BACKGROUND OF THE INVENTION

In recent years, reduction of the downtime that accompanies malfunction and stoppage of machines, the quality control of products, the reduction of the man-hours required for maintenance management, and the like have become serious problems in factory operation.

Accordingly, there is an increasing demand for monitoring conditions such as malfunctions, wear, and signs thereof with regard to machines, machine components, power sources (electric motors) of machines, power supplies of machines, consumable tools, and the like (hereinafter, objects related to such machines will be referred to as “devices”).

In addition, with regard to target processing objects such as the workpieces and manufactured products processed by these devices as well, there is an increasing demand for monitoring conditions such as the processing quality and signs of occurrence of defects.

Patent Document 1 discloses a technique for sampling a motor current flowing through a machining motor and monitoring for abnormalities in each operation process based on whether or not a standard deviation of the motor current exceeds the upper and lower limits for that operation process.

### CITATION LIST

### Patent Documents

[Patent Document 1] Japanese Unexamined Patent Application Publication No. 2007-52797 A

### SUMMARY OF INVENTION

### Technical Problem

In Patent Document 1, abnormality detection is performed based on the fluctuation of the value of the motor current. This fluctuation of the motor current becomes small in cases where the load applied to the machining motor is light, and is easily obscured by measurement noise. Accordingly, there are problems in that it becomes difficult to detect abnormalities.

In addition, the motor current described above varies with delay due to the control of the motor. Accordingly, when the motor current is used for abnormality detection, there are problems in that instantaneous abnormality detection becomes difficult.

It is therefore an object of the present invention to provide a technique for monitoring a condition of a device or a target processing object.

### Means for Solving the Problems

In order to solve the above problems, one representative monitoring system according to the present invention includes a time-series data acquisition unit configured to acquire voltage data relating to a drive voltage of an AC motor; a feature value computation unit configured to analyze a feature value of an abnormal voltage waveform in a time-series waveform of the voltage data; and a state estimation unit configured to estimate, based on the feature value of the abnormal voltage waveform, a condition of a device powered by the AC motor or a target processing object of the device.

### Effect of the Invention

The present invention is capable of monitoring the condition of a device or a target processing object.

Other problems, configurations and effects other than those described above will be made clear by the following description of the embodiments.

### BRIEF DESCRIPTION OF DRAWINGS

FIG. 1 is a figure that illustrates the relationship between the phase voltage and the phase current of a three-phase AC motor.

FIG. 2 is a block diagram illustrating a configuration of a first embodiment.

FIG. 3 is a diagram for explaining examples (a) to (d) of division reference information 12A.

FIG. 4 is a diagram for explaining a data flow of the feature value computation unit 13.

FIG. 5 is a diagram illustrating the standard deviation, the maximum value, and the minimum value in a voltage waveform.

FIG. 6 is a diagram illustrating example (a) to example (c) of a state estimation unit 14.

FIG. 7 is a block diagram illustrating the configuration of a second embodiment.

FIG. 8 is a diagram illustrating the process of the second embodiment.

FIG. 9 is a block diagram illustrating the configuration of a third embodiment.

FIG. 10 is a block diagram illustrating the configuration of a fourth embodiment.

FIG. 11 is a block diagram illustrating the configuration of the fifth embodiment.

FIG. 12 is a block diagram illustrating the configuration of an information conversion unit 17.

FIG. 13 is a block diagram illustrating the configuration of a sixth embodiment.

### DESCRIPTION OF EMBODIMENT(S)

### Operating Principle of the Embodiments

First, the reason why the load change of an AC motor can be captured by detecting an abnormal voltage waveform that occurs in the drive voltage of the AC motor will be explained.

Here, as an example of the abnormal voltage waveform, an abnormal voltage waveform caused by the dead time of the inverter will be described.

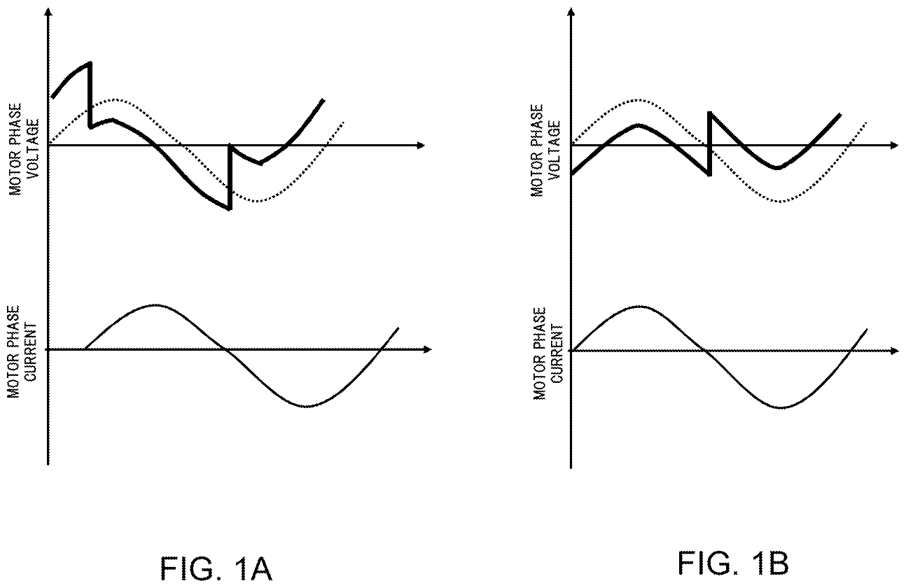

FIG. 1 is a diagram illustrating the relationship between the phase voltage and the phase current of the three-phase AC motor.

A three-phase AC motor is driven by three-phase AC supplied from an inverter. The inverter generates the AC by alternately turning positive and negative switching elements (hereinafter referred to as “upper and lower arms”) ON and OFF. The moment this AC becomes zero-crossing, the power supply circuit on the inverter side is short-circuited momentarily when the upper and lower arms are turned on at the same time. Accordingly, a period in which both the upper and lower arms turn OFF is provided. This period is called dead time.

In this dead time, since the current flowing through the AC motor is not switched smoothly, a discontinuous voltage change (hereinafter referred to as a “voltage drop”) occurs as indicated by the solid line in FIG. 1 in accordance with the ratio of the dead time to the switching cycle.

This voltage drop varies with the positive and negative phase currents, such that the phase voltage decreases during the period when the phase current is positive, and the phase voltage increases during the period when the phase current is negative. This phenomenon occurs similarly even in the line voltage, especially when the modulation rate is low.

This discontinuous change of the AC voltage becomes an abnormal voltage waveform having a 5^{th} harmonic, a 7^{th} harmonic, and further n-fold harmonic components with respect to the fundamental frequency of the AC, and causes torque pulsation. The waveforms illustrated by the dotted lines in FIG. 1(a) and FIG. 1(b) are the ideal motor phase voltages. In contrast, the waveforms illustrated by the thick line in FIG. 1(a) and FIG. 1(b) illustrate states in which abnormal voltage waveforms occur in the motor phase voltage.

In the case that this AC voltage is converted to DC by a coordinate transformation, an abnormal voltage waveform having a 6^{th} harmonic and further n-fold harmonic components with respect to the fundamental frequency of the AC appears in the DC voltage value. For example, in a case that DC conversion is performed from at least two AC drive voltages of the three-phase drive voltage, an abnormal voltage waveform having a 6^{th} harmonic and further n-fold harmonic components with respect to the fundamental frequency of the AC appears in the DC voltage fluctuation.

As an additional example, in the case that data on the motor speed is obtained from at least two AC drive voltages of the three-phase drive voltage, an abnormal voltage waveform having a 6^{th} harmonic and further n-fold harmonic components with respect to the fundamental frequency of the AC appears in the motor speed data.

It should be noted that the torque pulsation is also reflected in the current flowing through the AC motor via the control operation of the AC motor. However, for cases in which the impedance between the terminals of the AC motor is large, since the flowing current itself is small, the torque pulsation of the current is obscured by the measurement noise and becomes difficult to detect.

The next important point is that this abnormal voltage waveform modulates according to the load (power factor, phase) of the AC motor. FIG. 1(a) and FIG. 1(b) illustrate how the torque pulsation is modulated by changes in the load (power factor, phase).

FIG. 1(a) is a case in which the power factor is small and the phase lag is large. FIG. 1(b) is a case in which the power factor is large and the phase lag is small. In FIG. 1(b), since the maximum value and the minimum value of the motor phase voltage are smaller than cases in which the load is small, as illustrated in FIG. 1(a), the voltage between the peaks of the torque pulsation (peek to peek) is decreasing.

This is mainly because the current phase varies according to the load, and the pulsation of the voltage when the load is large is reduced as compared to when the load is small. Accordingly, by monitoring the modulation over time of the voltage amplitude caused by this abnormal voltage waveform, it becomes possible to monitor the change over time of the load of the AC motor. In accordance with the change in the load over time, it becomes possible to estimate the change in the wear of the device or the change in the condition of a target processing object over time.

Furthermore, since this modulation of the voltage amplitude occurs immediately as a result of the change of the current phase due to the load (power factor, phase), there is no control delay, and the modulation of the voltage amplitude changes instantaneously in response to the load change.

Accordingly, by detecting the modulation of the voltage amplitude caused by this abnormal voltage waveform, it is possible to detect the instantaneous change in the load of the AC motor. From this instantaneous change of load, it becomes possible to estimate changes of the instantaneous condition, such as damage, of the device or a target processing object.

It should be noted that this abnormal voltage waveform is not only caused by dead time. For example, in an AC motor having a small inertia to rotate the tools of a cutting machine, the change in the load appears as a speed fluctuation that can be detected by the speed sensor. This speed fluctuation is reflected in the control of the drive voltage. Accordingly, an abnormal voltage waveform appears as information of a load change in the time-series waveform of the drive voltage.

Next, specific embodiments will be described.

### First Embodiment

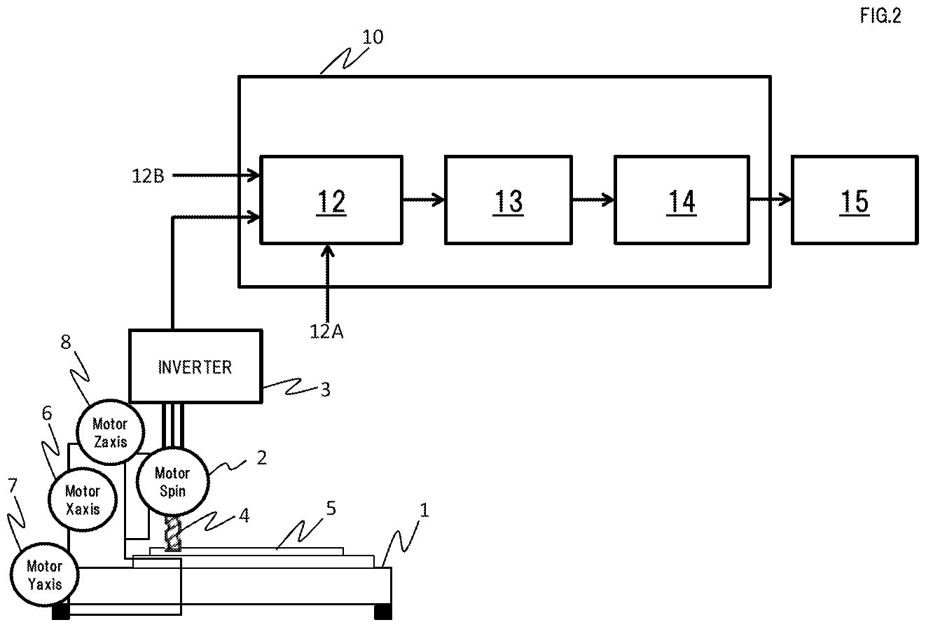

FIG. 2 is a block diagram illustrating the configuration of the first embodiment.

A milling machine 1 includes a spindle motor 2 constituted by a three-phase AC motor and an inverter 3 for driving the spindle motor 2 with three-phase AC. The spindle motor 2 performs cutting of a workpiece 5 by rotating the cutting tool 4. In addition, the milling machine 1 includes an X-axis motor 6 for three-dimensionally moving the stage for placing the workpiece 5 (or the tool 4), a Y-axis motor 7, and a Z-axis motor 8.

The monitoring system 10 monitors the milling machine 1. The monitoring system 10 includes a time-series data acquisition unit 12, a feature value computation unit 13, and a state estimation unit 14. The output of the state estimation unit 14 is input to the notification device 15. The time-series data acquisition unit 12 receives division reference information 12A and other sensing information 12B.

### Description of the Time-Series Data Acquisition Unit 12

The time-series data acquisition unit 12 samples voltage data relating to the drive voltage of the spindle motor 2 from the voltage line together with the other sensing information 12B before a filtering process of the inverter 3.

For example, the voltage data relating to the drive voltage is a voltage of at least one phase that is applied to the spindle motor 2. In addition, the voltage data relating to the drive voltage may be a voltage of at least one line. Furthermore, the voltage data relating to the drive voltage may be an AC voltage of at least two phases or at least 2 lines.

In addition, the above AC voltage value may be a D-axis voltage or a Q-axis voltage obtained by coordinate transformation (an operation for converting to coordinate values in rotational coordinates).

Furthermore, data of a command value for generating the above-mentioned voltage value by a control command may be used.

The time-series data acquisition unit 12 divides and extracts the voltage data acquired in time-series based on predetermined division reference information 12A.

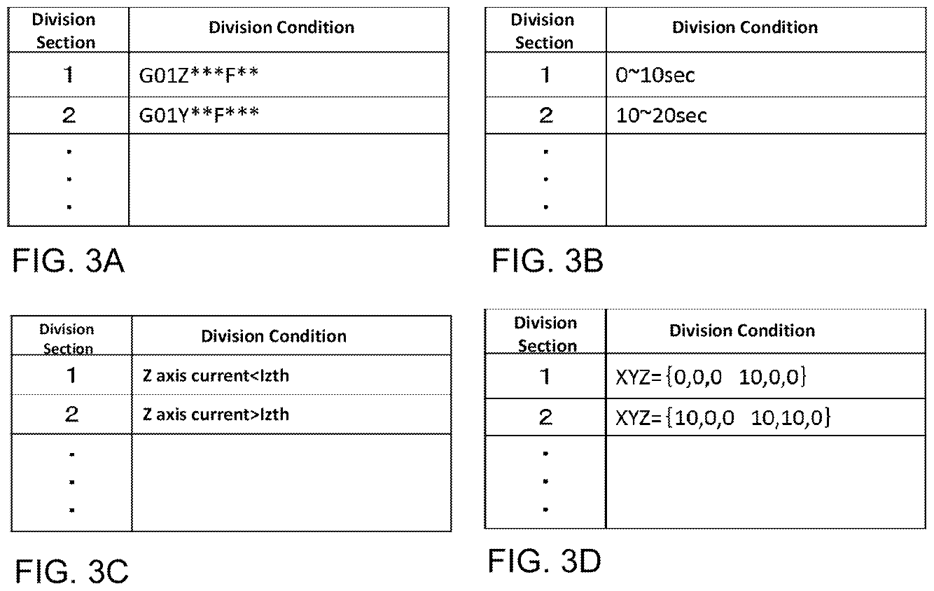

FIG. 3 is a diagram for explaining examples (a) to (d) of the division reference information 12A. In the figure, an example (a) shows a case where an NC code (a numerical control code) of the milling machine 1 is used as a division condition. By setting this NC code as a division section, voltage data is divided and extracted for each individual action of the numerical control of the milling machine 1.

Example (b) is a case in which the time required for the machining of the milling machine 1 is used as a division condition. By setting a time division as the division section, voltage data is divided and extracted for each period of the machining process of the milling machine 1, including an initial stage, an early stage, a middle stage, a later stage, and a final stage.

Example (c) is a case in which a threshold value determination of the motor current value is used as the division condition. By defining the division section on the basis of the motor current value, the voltage data is divided and extracted with the fluctuation of the machining load of the milling machine 1 serving as a divider.

Example (d) is a case in which the stage position of the milling machine 1(a machining position, a machining point, a machining path) is used as a division condition. By defining the division section on the basis of the stage position, the voltage data is divided and extracted for each specific cutting position of the workpiece 5.

In these examples (a) to (d), in a case that the division condition satisfies the conditions, the time-series data acquisition unit 12 stores a division start position of the time-series data, and in a case that the division condition ends and transitions to the next division section, stores a division end position. The time-series data acquisition unit 12 divides and extracts the voltage data according to the sequentially stored division start position and division end position.

It should be noted that, in addition to the voltage data of the drive voltage, the time-series data acquisition unit 12 similarly performs classification and extraction of the data for the other sensing information 12B.

In the subsequent processes, unless otherwise specified, the voltage data and the sensing information 12B are processed section by section.

### Explanation of the Feature Value Computation Unit 13

The feature value computation unit 13 analyzes the time-series waveform of each individual voltage data from the time-series data acquisition unit 12, and computes a feature value for information related to the abnormal voltage waveform (torque pulsation or the like).

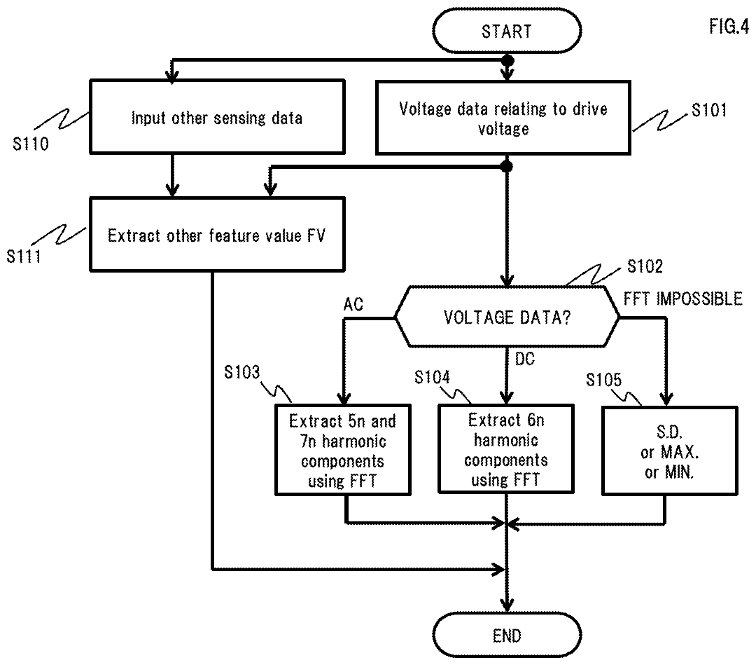

FIG. 4 is a diagram illustrating a data flow of the feature value computation unit 13. Hereinafter, the operation of the feature value computation unit 13 will be described in accordance with the step numbers illustrated in FIG. 4.

Step S101: The feature value computation unit 13 acquires voltage data relating to the drive voltage or data relating to the motor speed obtained from the drive voltage from the time-series data acquisition unit 12. Hereinafter, the data values derived from these voltages will collectively be referred to as “voltage data”.

Step S102: The feature value computation unit 13 branches its operations according to the acquired voltage data

In a case that the voltage data is an AC value, the feature value computation unit 13 shifts its operation to Step S103.

In a case that the voltage data is a DC value, the feature value computation unit 13 shifts its operation to Step S104.

On the other hand, in a case that frequency analysis is difficult, such as in cases where the data sections of the voltage data are short, or the S/N is low, the feature value computation unit 13 shifts its operation to Step S105.

Step S103: In a case that the acquired voltage data is an AC voltage value, the feature value computation unit 13 performs frequency analysis by using a fast Fourier transform (hereinafter, referred to as “FFT”), and extracts 5-fold, 7-fold, and harmonic components thereof (collectively referred to as 5n and 7n harmonic components in the figures) with respect to the AC fundamental frequency. The feature value computation unit 13 sets the 5n and 7n harmonic components as feature values of abnormal voltage waveforms (torque pulsation or the like).

Step S104: In a case that the acquired voltage data is a DC-converted voltage, the feature value computation unit performs frequency analysis by using FFT, and extracts 6-fold and harmonic components (collectively referred to as 6n harmonic components in the figures) thereof with respect to the AC fundamental frequency. The feature value computation unit 13 sets the 6n harmonic components as a feature value of an abnormal voltage waveform (torque pulsation or the like).

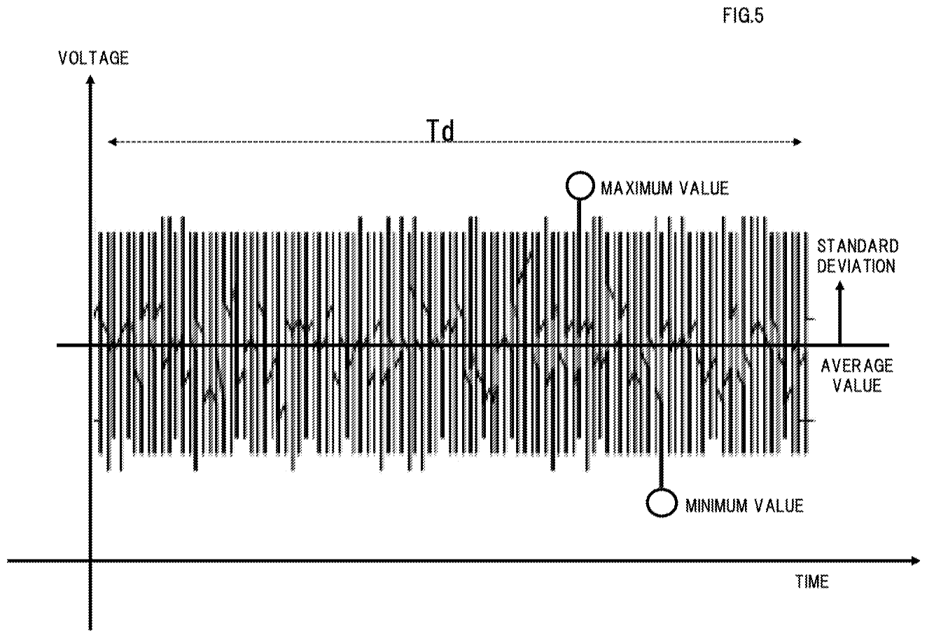

Step S105: In the case that frequency analysis of the acquired voltage data is difficult by FFT, the feature value computation unit 13 obtains the standard deviation, the maximum value, or the minimum value of the voltage data of the divided section Td as illustrated in FIG. 5, and then the feature value computation unit 13 sets this as a feature value of the abnormal voltage waveform (torque pulsation or the like).

Step S110: The feature value computation unit 13 acquires other sensing information 12B from the time-series data acquisition unit 12.

Step S111: The feature value computation unit 13 extracts a feature amount FV from the other sensing information 12B. For example, with regard to the sensing information 12B, a fundamental statistic value, a frequency component (the same as that in Steps S103 to 105 or the like), the slope of the waveform, an overshoot amount, or the like is set as the feature value FV of the abnormal voltage waveform.

Further, the feature value FV may be extracted from new information created by performing an operation with the drive voltage and the other sensing information 12B together (for example, power calculated by an operation on the voltage and current).

### Description of the State Estimation Unit 14

The state estimation unit 14 detects a change in the load applied to the spindle motor 2 based on the feature value FV calculated by the feature value computation unit 13, and estimates a condition of the tool 4 of the device or the workpiece 5.

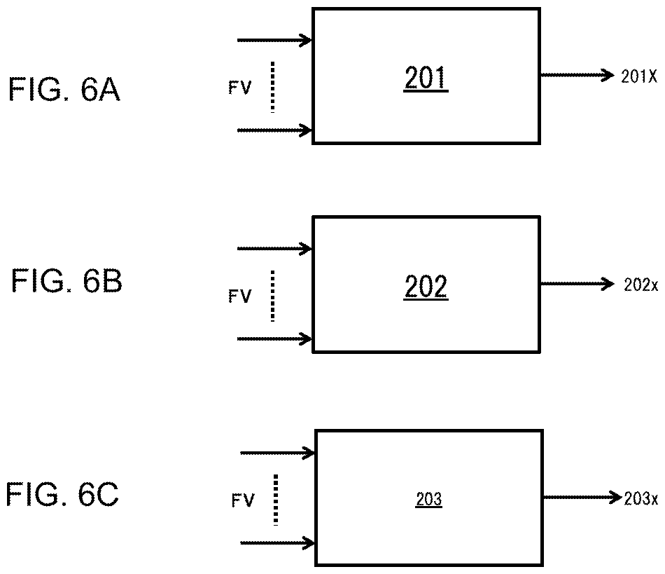

FIG. 6 is a diagram illustrating examples (a) to (c) of the state estimation unit 14. In this figure, in example (a), a threshold comparator 201 performs threshold determination with respect to the feature value FV obtained by the feature value computation unit 13, and outputs the condition of a target object as a state value 201x.

In a case that there is one feature value FV and it exceeds the threshold value (in the case that greater than or equal to the threshold value is considered abnormal), an abnormal state value 201x is output, and in a case that the feature value is less than the threshold value, a normal state value 201x is output. In a case that there a multiple feature values FV, an abnormal state value 201x may be output if the number of abnormal threshold determination results for each feature value FV is greater than or equal to a certain number, for example. In addition, a comprehensive determination as to whether or not there is an abnormality may be output as the state value 201x based on the number of the feature values FV determined to be abnormal or a combination thereof.

The example (b) shows a configuration in which a degree of abnormality of a target object is output by using an abnormality detection model 202 created in advance; that is, a multidimensional spatial cluster created using normal or abnormal data As a method of detecting an abnormality, for example, a method such as an MT method or support vector machines (hereinafter referred to as “SVM”) may be used. The abnormality detection model 202 processes the input of the feature value FV by using the multi-dimensional spatial cluster, and outputs the degree of abnormality 202x as the condition of the target object.

Example (c) is a supervised learning model 203 that is created in advance and then updated at any time. For example, a classification model or a regression model is used to output abnormal and normal state values. With regard to the classification model, a classification model is created by a method such as SVM or the like using a data set in which feature values FV are distributed in advance for respective discrete state values such as normal and abnormal. With regard to the regression model, a regression equation is created using a method such as general linearization modeling that utilizes a dataset in which continuous state values (for example, tool wear amount or the like) and feature value FV data are linked in advance, and the state values are output. By means of such processing, a state value 203x is output as the condition of the target object.

### Description of Notification Device 15

The condition information estimated by the state estimation unit 14 is output to the notification device 15. The notification device 15 notifies, by visual information or audio information, the supervisor of the milling machine of the condition information such as the degree of wear of the tool 4 of the device or the machining quality of the workpiece 5. In some cases, a remote management supervisor is notified via a network or the like.

### Effects of the First Embodiment

In the first embodiment, the following effects (1) to (10) can be mainly achieved.
(1) In the first embodiment, it is possible to comprehend the condition of the device or the target processing object in real time. Accordingly, it becomes easier to optimize tool replacement timing and reduce the number of man-hours for quality control, thereby contributing to a reduction in the operation cost of the factory.
(2) In the first embodiment, the condition of the device and target processing object is estimated based on the voltage data relating to the drive voltage of the spindle motor 2. Unlike the motor current, this voltage data relating to the drive voltage does not become small even in situations where the load on the spindle motor 2 is light. Accordingly, the voltage data is unlikely to be obscured by measurement noise, and there is little possibility of missing abnormalities in the condition. Especially, the present invention is excellently suited for applications of detecting slight changes in a condition over a long period of time, such as degradation.
(3) In the first embodiment, the voltage data relating to the drive voltage is used as a basis of the determination. Because there is no control delay as with the motor current, this voltage data can be used to instantaneously detect abnormalities in the condition. Accordingly, the present invention is suitable for applications of detecting instantaneous condition changes, such as damage and malfunction of the device or the target processing object, without delay.
(4) In the first embodiment, with regard to the voltage data of the AC value, an amount of a frequency component that is 5n-fold or 7n-fold with respect to the fundamental frequency (where n is a natural number) is detected as the feature value FV of the abnormal voltage waveform (torque pulsation or the like). By estimating the condition of the device or the target processing object based on the feature value FV of this abnormal voltage waveform (torque pulsation or the like), other frequency components (those arising from noise or normal motor control) are less likely to be misinterpreted as abnormal voltage waveforms, enabling more accurate condition estimation.
(5) In the first embodiment, with regard to the voltage data of the DC, an amount of a frequency component that is 6n-fold with respect to the fundamental frequency (where n is a natural number) is detected as the feature value FV of the abnormal voltage waveform (torque pulsation or the like). By estimating the condition of the device or the target processing object based on the feature value FV of this abnormal voltage waveform (torque pulsation or the like), other frequency components (those arising from noise or normal motor control) are less likely to be misinterpreted as abnormal voltage waveforms, enabling more accurate condition estimation.
(6) In particular, since the voltage data of the DC value does not have an AC fundamental wave, it is possible to detect subtle abnormal voltage waveforms with high accuracy. As a result, the estimation accuracy of the condition can be increased.
(7) In the first embodiment, in cases that frequency analysis is not suitable, such as when the amount of data of the voltage data is small, when the noise of the voltage data is large, or the like, the feature value FV of the abnormal voltage waveform (torque pulsation or the like) is detected based on the standard deviation, the maximum value, or the minimum value of the voltage data relating to the drive voltage. For this reason, even under conditions where sufficient voltage data cannot be obtained, the condition can be flexibly monitored.
(8) In the first embodiment, the feature of an abnormal voltage waveform is applied to a learning model subjected to machine learning in order to estimate the condition of the device or the target processing object. Such a learning model is created by machine learning that corresponds to the individual operation of the milling machine 1. Accordingly, it is possible to estimate the condition in accordance with the individual characteristics of the milling machine 1.
(9) In the first embodiment, voltage data is acquired from prior to the filter processing of the output stage of the inverter 3. Accordingly, abnormal voltage waveforms are not impaired by filtering, and it is possible to more accurately detect the feature value FV of the abnormal voltage waveform. Accordingly, the estimation of the condition becomes more accurate.
(10) In the first embodiment, the voltage data is divided and extracted according to various division conditions. Accordingly, it is possible to estimate the condition of the device and the target processing object for each section of the voltage data.

### Second Embodiment

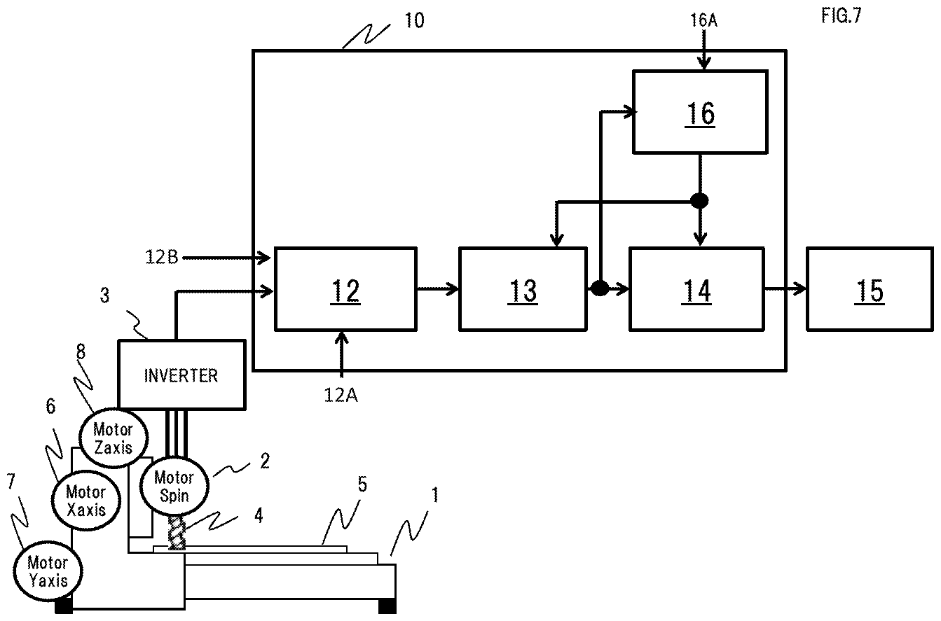

FIG. 7 is a block diagram illustrating the configuration of the second embodiment.

In this figure, the same components as those of the first embodiment are denoted by the same reference numerals as those of the first embodiment, and a redundant description thereof is omitted.

The feature of the second embodiment as compared with the first embodiment is that an estimation method updating unit 16 is provided.

The estimation method updating unit 16 updates the model (the abnormality detection model 202 or the supervised learning model 203) at any time based on the results of the feature value computation unit 13 and the state information 16A (discrete or continuous information) of the device or the target processing object. The estimation method updating unit 16 maintains the feature value FV extracted by the feature value computation unit 13 or the model used by the state estimation unit 14 in the latest state based on the updated model.

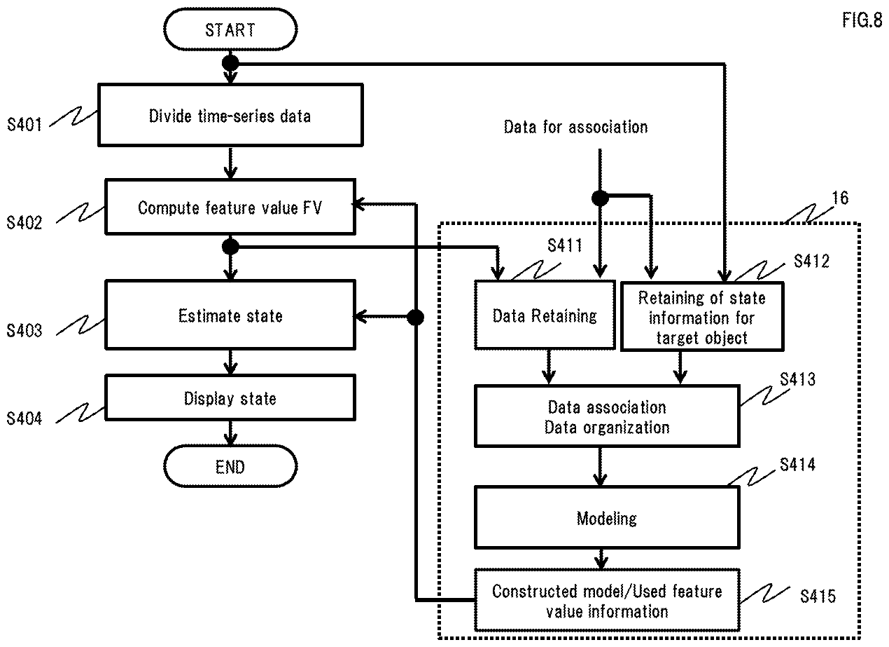

FIG. 8 is a diagram for explaining the overall process (Step S401 to S404) of the second embodiment and the process of the estimation method updating unit 16 (Step S411 to S415).

### Overall Process of the Second Embodiment

The overall process of the second embodiment will be described with reference to FIG. 8.

Step S401: The time-series data acquisition unit 12 acquires voltage data relating to the drive voltage of the spindle motor 2 output from the inverter 3 together with the other sensing information 12B in time series.

The time-series data acquisition unit 12 divides the voltage data acquired in the time-series based on the predetermined division reference information 12A.

Step S402: The feature value computation unit 13 acquires the voltage data from the time-series data acquisition unit 12 and computes the feature value FV of the abnormal voltage waveform.

Step S403: The state estimation unit 14 acquires the feature value FV of the abnormal voltage waveform from the feature value computation unit 13. The state estimation unit 14 estimates the condition of the device or a target processing object by applying the feature value FV to a previously constructed model.

Step S404: The condition information estimated by the state estimation unit 14 is output to the notification device 15. The notification device 15 notifies, by visual information or audio information, the supervisor of the milling machine 1 of the condition information such as the degree of wear of the tool 4 of the device or the machining quality of the workpiece 5.

### Explanation of the Estimation Method Updating Unit 16

Next, the process of the estimation method updating unit 16 will be described with reference to FIG. 8.

Step S411: The estimation method updating unit 16 operates concurrently in the background of Steps S401 to S404. The estimation method updating unit 16 acquires a feature value FV (such as the feature amount FV described in the first embodiment) from the feature value computation unit 13 and retains the acquired feature value FV as a record.

Step S412: The estimation method updating unit 16 collects and retains the state information 16A of the device and the target processing object. This state information 16A may include measured values or input values that indicate whether the status of a mechanical component, a tool or the like is normal or abnormal, an index value from when a quality check was performed, or a right/wrong score for the condition notified by the notification device 15.

Step S413: The estimation method updating unit 16 associates the feature value collected in Step S411 with the state information 16A collected in Step S412, and creates a data set suitable for modeling. The association described here can use an association based on data of the time when machining or inspection was performed, an association based on ID numbers or the like unique to the workpieces, an association based on production plan information, an association based on control data records in the machine, an association based on maintenance records, an association based on manual input by an operator, or the like.

It should be noted that, in the case that the state information 16A collected in Step S412 is insufficient, the estimation method updating unit 16 discards, from among the feature values FV collected in Step S411, those feature values FV that cannot be associated.

In addition, when association is performed based on time, even if the times do not completely coincide with each other, if the times coincide with each other within a predetermined time period, the estimation method updating unit 16 recognizes the data to be synchronized and performs the association.

Step S414: In the case that the data set created in Step S413 reaches a predetermined number of samples, the estimation method updating unit 16 creates thresholds for determining normal versus abnormal, creates mathematical equations for calculating the state values, and creates models such as a cluster space that represents normal states using multivariate analysis, machine-learning, and artificial intelligence (AI).

In the creation of the above-described threshold, the state information 16A of Step S412 is used as an objective variable, the feature value FV of Step S411 is used as an explanatory variable, and a border value of the feature value FV for determining abnormal versus normal is determined using Receiver Operating Characteristic (ROC) curves or the like.

In addition, in the creation of the above-described mathematical equations, the state information 16A of Step S412 is used as an objective variable, the feature value FV of Step S411 is used as an explanatory variable, and a classification or a regression model is created using support vector machines (SVM) or a generalized linearization modeling technique.

In addition, in the creation of the above-described cluster space, the cluster space is created by using a method such as a MT method, a one-class SVM, or the like using only the feature values FV of Step S411 that correspond to information that can be regarded as a normal state in the state information 16A of Step S412.

Step S415: The estimation method updating unit 16 sends the latest information, such as the model constructed by Step S414 or the feature value FV, to the feature value computation unit 13 and the state estimation unit 14. The feature value computation unit 13 and the state estimation unit 14 operate according to the latest information.

Here, the update timing of the model and the feature value FV may, for example, be performed in a case where a parameter of the model constructed by the estimation method updating unit 16 changes with respect to a parameter of the model used by the state estimation unit 14 by greater than or equal to a threshold value, a case where the number (terms) of the feature values FV to be used increases or decreases (the equation or the space changes), or the like.

### Effects of the Second Embodiment

In the second embodiment, effects similar to those of the first embodiment can be obtained.

Further, in the second embodiment, since the estimation method updating unit 16 updates the model for estimating the condition at any time, the estimation operation of the condition can be increased in a growing fashion.

### Third Embodiment

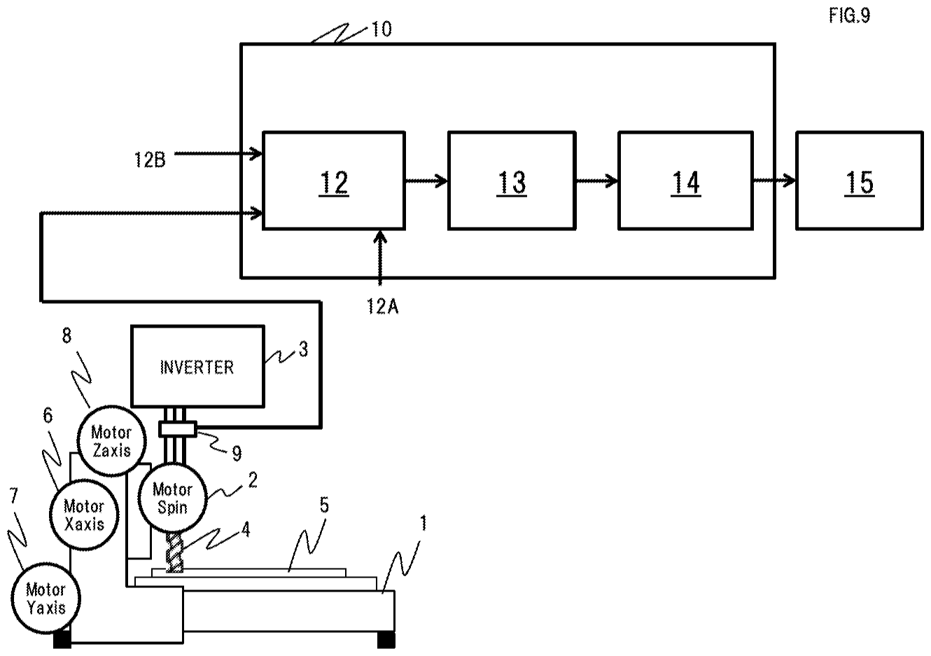

FIG. 9 is a block diagram illustrating the configuration of the third embodiment. In this figure, the same components as those of the first embodiment are denoted by the same reference numerals as those of the first embodiment, and a redundant description thereof is omitted.

The feature of the third embodiment as compared with the first embodiment is that, in the method of acquiring the voltage data relating to the drive voltage, rather than obtaining the voltage data from within the inverter 3, an external voltage sensor 9 installed in the three-phase wiring of the inverter 3 and the spindle motor 2 is used.

The external voltage sensor 9 performs two-line or two-phase voltage measurement of the three-phase wiring.

As a method of measuring the voltage, a method of measuring the voltage with resistance division of the voltage of the motor terminal using a differential probe, optical coupling, magnetic coupling, and a method of directly measuring the voltage of the motor terminal using a voltage sensor isolated by capacitive coupling can be used, and it is also possible to use a non-contact voltage sensor capable of measuring the voltage from above the wire coating.

### Effects of the Third Embodiment

In the third embodiment, effects similar to those of the first embodiment can be obtained.

Further, in the third embodiment, even in the case of a system that cannot acquire the information of the drive voltage from the inverter 3, it is possible to provide a system that can estimate the state of the device or the target processing object.

### Fourth Embodiment

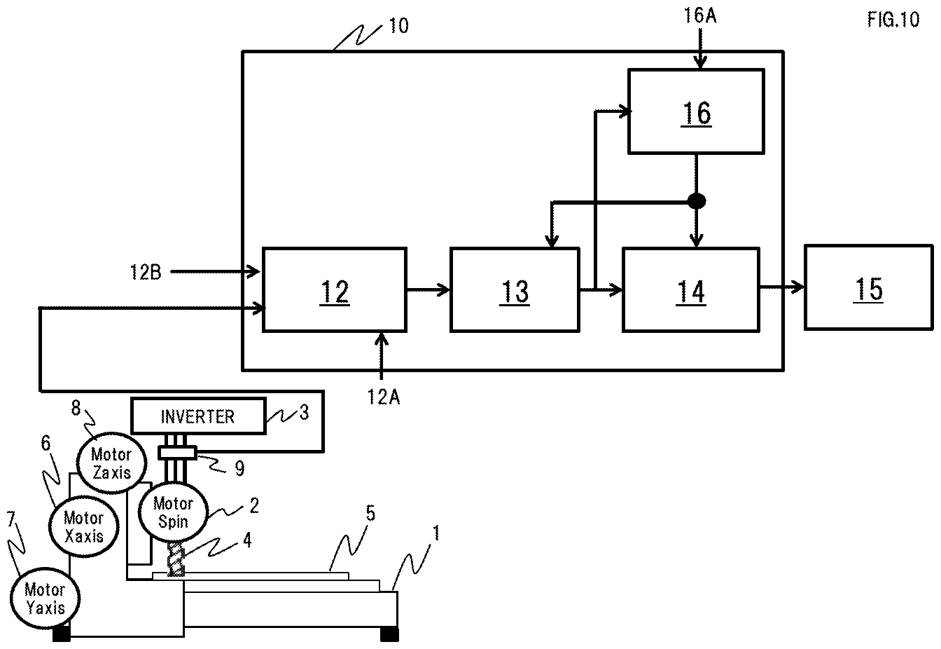

FIG. 10 is a block diagram illustrating the configuration of the fourth embodiment.

In this figure, the same components as those of the second embodiment are denoted by the same reference numerals as those of the second embodiment, and a redundant description thereof is omitted.

The feature of the fourth embodiment as compared with the second embodiment is that, in the method of acquiring the voltage data relating to the drive voltage, rather than obtaining the voltage data from the inverter 3, an external voltage sensor 9 installed in the three-phase wiring of the inverter 3 and the spindle motor 2 is used.

The external voltage sensor 9 performs two-line or two-phase voltage measurement of the three-phase wiring.

As a method of measuring the voltage, a method of measuring the voltage with resistance division of the voltage of the motor terminal using a differential probe, optical coupling, magnetic coupling, and a method of directly measuring the voltage of the motor terminal using a voltage sensor isolated by capacitive coupling can be used, and it is also possible to use a non-contact voltage sensor capable of measuring the voltage from above the wire coating.

### Effects of the Fourth Embodiment

In the fourth embodiment, effects similar to those of the second embodiment can be obtained.

Further, in the fourth embodiment, even in the case of a system that cannot acquire the information of the drive voltage from the inverter 3, it is possible to provide a system that can estimate the state of the device or the target processing object.

### Fifth Embodiment

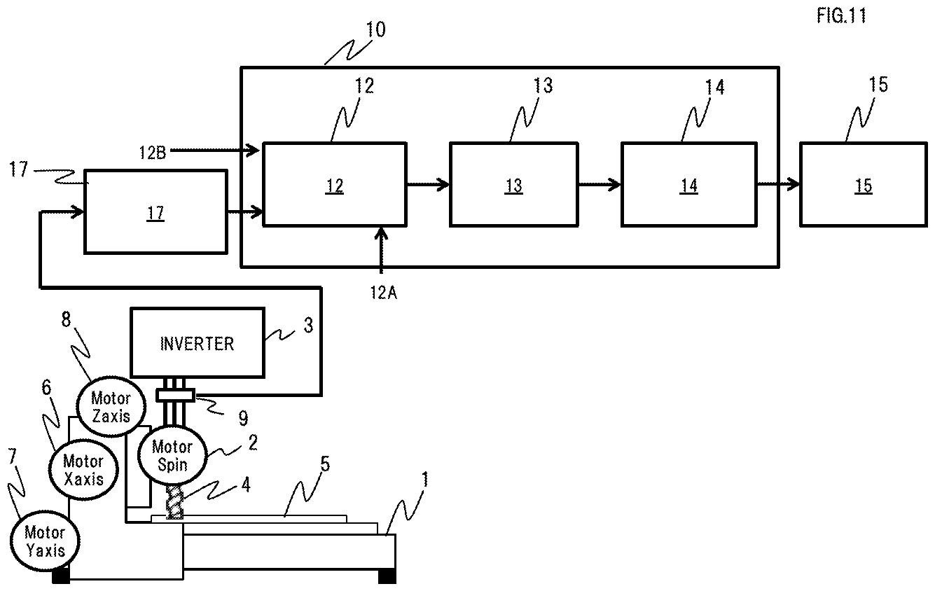

FIG. 11 is a block diagram illustrating the configuration of the fifth embodiment.

In this figure, the same components as those of the third embodiment are denoted by the same reference numerals as those of the third embodiment, and a redundant description thereof is omitted.

The feature of the fifth embodiment as compared with the third embodiment is that it includes an information conversion unit 17 for performing coordinate conversion of the voltage data obtained from the external voltage sensor 9 from an AC value to a DC value.

### Description of the Information Conversion Unit 17

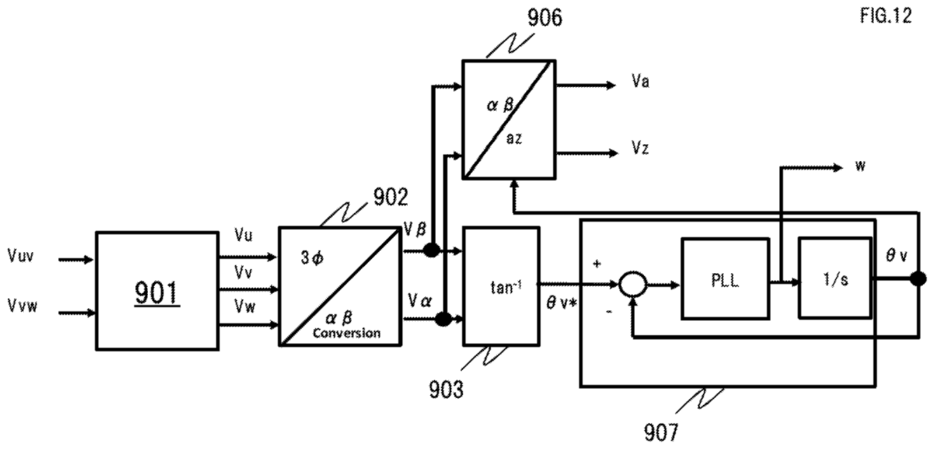

FIG. 12 is a block diagram illustrating the configuration of the information conversion unit 17. In this figure, the information conversion unit 17 includes a phase voltage conversion unit 901, a three-phase two-phase conversion unit 902, an arc tangent calculation unit 903, a rotational coordinate converter 906, and a phase calculator 907.

Originally, coordinate transformation would require the position information of the rotor of the spindle motor 2, but in the present embodiment, assuming a case in which the rotor position information is not acquired, coordinate transformation is performed using the phase information of the voltage as an alternative to the position information of the rotor.

Description will be made of the contents of the process with respect to an example in which a voltage between two lines is input. First, the input line voltages Vuv and Vvw are converted from line voltages to phase voltages by the phase voltage conversion unit 901 based on the following equations. It should be noted that, in the case that a phase voltage is input, this process is omitted.

Vu=(⅔){Vuv+Vvw/2} (Equation 1)

Vw=−(⅔){Vvw+Vuv/2} (Equation 2)

Vv=−(Vu+Vw) (Equation 3)

Next, the voltages converted into phase voltages are αβ converted by the three-phase two-phase conversion unit 902 based on the following equations.

Vα=(⅔){Vu−Vv/2−Vw/2} (Equation 4)

Vβ=(1/√(3)){Vv−Vw} (Equation 5)

Further, in the arc tangent calculation unit 903, the voltage phase θv* is calculated.

θv*=tan⁻¹(Vβ/Vα) (Equation 6)

Then, in the phase calculator 907, the coordinate converted phase θv is generated by causing the phase locked loop (PLL) to follow the phase of the voltage phase θv*. The rotational coordinate converter 906 converts Vα and Vβ into DC flow rates Va and Vz using the coordinate conversion phase θv.

Va=Vα·cos(θv)+Vβ·sin(θv) (Equation 7)

Vz=−Vα·sin(θv)+Vβ·cos(θv) (Equation 8)

In addition, at this time, the speed information w of the drive voltage, that is, the motor speed estimate value w, is output from the phase calculator 907.

This motor speed estimate value w also input to the time-series data acquisition unit 12 together with Va and Vz as one of the DC conversion values (data corresponding to a DC voltage) obtained from at least two AC drive voltages of the three-phase drive voltage. Since Va, Vz, and w are all DC values in the feature value computation unit 13, the amount of the frequency component of the 6^{th} harmonic with respect to the fundamental wave frequency is extracted and used as the feature value FV of the abnormal voltage waveform (torque pulsation). The state estimation unit 14 estimates the condition based on the feature value FV of the abnormal voltage waveform (torque pulsation).

### Effects of the Fifth Embodiment

In the fifth embodiment, effects similar to those of the third embodiment can be obtained.

Furthermore, in the fifth embodiment, since a DC value is used, and there is no pulsation of the alternating fundamental wave, it is possible to detect subtle abnormal voltage waveforms with high accuracy. As a result, the estimation accuracy of the condition can be increased.

### Sixth Embodiment

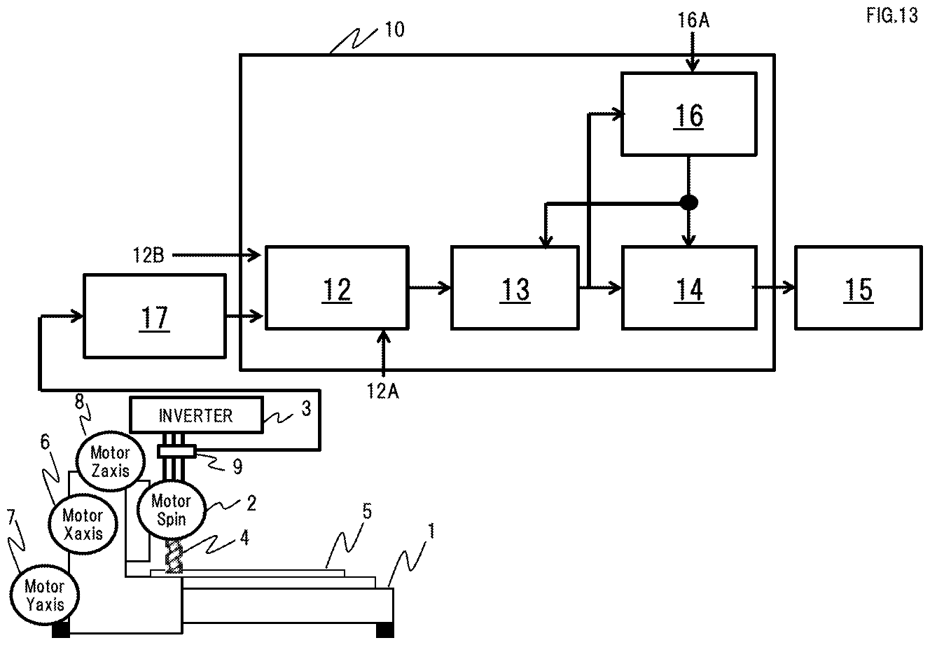

FIG. 13 is a block diagram illustrating the configuration of the sixth embodiment.

In this figure, the same components as those of the fifth embodiment are denoted by the same reference numerals as those of the fifth embodiment, and a redundant description thereof is omitted.

The feature of the sixth embodiment as compared with the fifth embodiment is that it includes an estimation method updating unit 16. Since the operation of the estimation method updating unit 16 is the same as that of the second embodiment, a redundant description thereof will be omitted.

### Effects of the Sixth Embodiment

In the sixth embodiment, effects similar to those of the fifth embodiment can be obtained. Further, in the sixth embodiment, since the estimation method updating unit 16 updates the model for estimating the condition at any time, the estimation operation of the condition can be increased in a growing fashion.

In the above embodiments, the milling machine 1 was taken as a device powered by an AC motor. However, the present invention is not limited thereto. In the present invention, a device powered by an AC motor can be monitored.

In addition, in the above embodiments, a device in a factory has been described. However, the present invention is not limited thereto. For example, the present invention may also be directed to monitoring machines powered by AC motors such as electric vehicles, railway vehicles, or elevators. By incorporating the monitoring device of the present invention into these machines, it becomes possible to reliably monitor devices for wear, malfunction, and signs thereof.

Furthermore, in the embodiments described above, it should be noted that the monitoring system 10 is installed as an apparatus separate from the device. However, the present invention is not limited thereto. The monitoring system 10 may be incorporated internally in the inverter 3 to form an inverter (a three-phase inverter) with a monitoring system. In addition, the monitoring system 10 may be incorporated internally in the AC motor to form an alternating motor or a control device with a monitoring system.

In addition, in the above embodiments, a description has been provided for each individual embodiment. However, it is also possible to combine some or all of these embodiments.

### REFERENCE SIGN LIST

1 . . . Milling machine, 2 . . . Spindle motor, 3 . . . Inverter, 4 . . . Tool, 5 . . . Workpiece, 6 . . . X-axis motor, 7 . . . Y-axis motor, 8 . . . Z-axis motor, 9 . . . External voltage sensor, 10 . . . Monitoring system, 12 . . . Time-series data acquisition unit, 12A . . . Division reference information, 12B . . . Sensing information, 13 . . . Feature value computation unit, 14 . . . State estimation unit, 15 . . . Notification device, 16 . . . Estimation method updating unit, 16A . . . State information, 17 . . . Information conversion unit, 201 . . . Threshold comparator, 201x . . . State value, 202 . . . Abnormality detection model, 202x . . . Degree of abnormality, 203 . . . Supervised learning model, 203x . . . State value, 901 . . . Phase voltage conversion unit, 902 . . . Three-phase two-phase conversion unit, 903 . . . Arc tangent calculation unit, 906 . . . Rotational coordinate converter, 907 . . . Phase calculator, FV . . . Feature value, Td . . . Section

1. A monitoring system comprising:
a time-series data acquisition unit configured to acquire voltage data relating to a drive voltage of an AC motor;
a feature value computation unit configured to analyze a feature value of an abnormal voltage waveform in a time-series waveform of the voltage data; and
a state estimation unit configured to estimate, based on the feature value of the abnormal voltage waveform, a condition of a device powered by the AC motor or a target processing object of the device.

2. The monitoring system according to claim 1, wherein:
the feature value computation unit obtains, as the abnormal voltage waveform, a torque pulsation included in the time-series waveform of the voltage data.

3. The monitoring system according to claim 1, wherein:
the time-series data acquisition unit acquires the voltage data relating to at least one AC drive voltage from a three-phase drive voltage of the AC motor; and
the feature value computation unit obtains, as the feature value of the abnormal voltage waveform, at least one amount of a frequency component that is 5n-fold or 7n-fold, where n is a natural number, of a fundamental frequency of the three phase drive voltage from the time-series waveform of the voltage data.

4. The monitoring system according to claim 1, wherein:
the time-series data acquisition unit acquires the voltage data relating to DC voltage fluctuations obtained by DC conversion from at least two AC drive voltages of a three-phase drive voltage of the AC motor; and
the feature value computation unit obtains, as the feature value of the abnormal voltage waveform, at least one amount of a frequency component that is 6n-fold, where n is a natural number, of a fundamental frequency of the three phase drive voltage from the time-series waveform of the voltage data.

5. The monitoring system according to claim 1, wherein:
the time-series data acquisition unit acquires data relating to a motor speed of the AC motor from at least two AC drive voltages of a three-phase drive voltage of the AC motor; and
the feature value computation unit obtains, as the feature value, at least one amount of a frequency component that is 6n-fold, where n is a natural number, of a fundamental frequency of the three phase drive voltage from a time-series waveform of the data relating to the motor speed.

6. The monitoring system according to claim 1, wherein:
the time-series data acquisition unit acquires the voltage data from prior to a filtering process of an inverter that supplies AC power to the AC motor.

7. The monitoring system according to claim 1, wherein:
the time-series data acquisition unit acquires the voltage data by a non-contact voltage sensor that measures voltage without electrically connecting to a voltage line.

8. The monitoring system according to claim 1, wherein:
the feature value computation unit obtains, as the feature value of the abnormal voltage waveform, an amount capable of being converted to a standard deviation of the voltage data.

9. The monitoring system according to claim 1, wherein:
the state estimation unit is configured to:
include a model unit configured to store a model that represents a relationship between the feature value of the abnormal voltage waveform and the condition; and
estimate the condition by applying the feature value of the abnormal voltage waveform analyzed by the feature value computation unit to the model stored in the model.

10. The monitoring system according to claim 9, further comprising:
an estimation method updating unit configured to collect the feature value of the abnormal voltage waveform and actual state information of the condition as a data set, and generate and update the model based on the data set.

11. A monitoring method for monitoring a device powered by an AC motor and estimating a condition of at least one of the device or a target processing object of the device, the method comprising:
a data acquisition step of acquiring voltage data relating to a drive voltage of the AC motor;
an analysis step of analyzing a feature value of an abnormal voltage waveform included in a time-series waveform of the voltage data; and
a situation estimation step of estimating the condition based on the feature value of the abnormal voltage waveform.

12. The monitoring method according to claim 11, wherein:
the analysis step obtains, as the feature value of the abnormal voltage waveform, a torque pulsation included in the time-series waveform of the voltage data.
